(19) United States
(12) Patent Application Publication
(10) Pub. No.: US 2026/0212151 A1
(43) Pub. Date: Jul. 23, 2026

(54) SYSTEM AND METHOD FOR GENERATING SYNTHETIC PERSONA

(71) Applicant: Plus Company Canada Inc., Quebec (CA)

(72) Inventor: Sebastien David, Outremont (CA)

(73) Assignee: Plus Company Canada Inc., Quebec (CA)

(21) Appl. No.: 19/400,996

(22) Filed: Nov. 25, 2025

Related U.S. Application Data
(60) Provisional application No. 63/747,617, filed on Jan. 21, 2025.

(51) Int. Cl. G06N 3/006

(52) U.S. Cl. CPC G06N 3/006

(57) ABSTRACT

A persona management system can receive, from a plurality of data sources, attribute data representing demographic, behavioral, and contextual variables for a first population of individuals. The system can then generate a synthetic-population dataset that preserves statistical relationships among the attribute data. Subsequently, the system can detect dependencies among the attributes based on correlation and influence coefficients and generate an influence data structure representing the strength and direction of attribute relationships. The system can then sample attributes from the synthetic-population dataset using the influence data structure to generate a plurality of synthetic personas representing a second population of individuals. The system can store the plurality of synthetic personas in a persona database. The system can then generate a response report indicating analytical insights from the synthetic personas by aggregating persona-specific dialog responses using retrieval-augmented reasoning in conjunction with a large-language model.

### RELATED APPLICATION

This application claims the benefit of U.S. Provisional Application No. 63/747,617, Attorney Docket Number PLUS25-1001PSP, titled “System and Method for Creating Artificial Persona,” by inventor Sebastien David, filed 21 Jan. 2025.

### BACKGROUND

### Field

This disclosure is generally related to systems and methods for constructing synthetic personas and using those personas in data-driven conversational analysis.

### Related Art

Modern organizations often rely on market research to assist decision making and to promote products, services, or brand awareness. Conventional market research typically involves actual human data. However, large-scale human studies are time consuming and costly. Furthermore, using actual personal information for market research incurs privacy and security concerns.

### SUMMARY

One embodiment described herein can provide a method and system for synthetic persona generation. During operation, the system can receive, from a plurality of data sources, attribute data representing demographic, behavioral, and contextual variables for a first population of individuals. The system can then generate a synthetic-population dataset that preserves statistical relationships among the attribute data. Subsequently, the system can detect dependencies among the attributes based on correlation and influence coefficients and generate an influence data structure representing the strength and direction of attribute relationships. The system can then sample attributes from the synthetic-population dataset using the influence data structure to generate a plurality of synthetic personas representing a second population of individuals. The system can store the plurality of synthetic personas in a persona database. The system can then generate a response report indicating analytical insights from the synthetic personas by aggregating persona-specific dialog response using retrieval-augmented reasoning in conjunction with a large-language model. The system can subsequently display the response report on a client interface.

In a variation on this embodiment, the system can detect the dependencies by applying a machine-learning model to determine how a change in one attribute affects at least one other attribute within the synthetic-population dataset.

In a variation on this embodiment, the system can generate the synthetic-population dataset by merging a first dataset comprising demographic or transactional information of the second population, a second dataset comprising behavioral records or survey responses of the first population, and a third dataset comprising market, environmental, or social-trend information obtained from external data providers.

In a variation on this embodiment, the system can generate the plurality of synthetic personas by performing sequential probabilistic sampling that preserves conditional probabilities derived from the influence data structure.

In a variation on this embodiment, the system can generate the response report by retrieving persona-specific information from the persona database and generating a response by feeding a prompt constructed based on the retrieved persona-specific information to the large-language model.

In a further variation, the system can analyze dialog transcripts for dialog with the large-language model to identify emergent behavioral patterns across personas.

In a further variation, the system can generate the response by further identifying correlations, trends, or emerging patterns across a plurality of persona interactions and generating the response representing an insight or recommendation based on the identified patterns.

In a variation on this embodiment, the system can apply a neural-network model to rank attributes by correlation strength and direction.

### BRIEF DESCRIPTION OF THE FIGURES

FIG. 1 presents a block diagram illustrating a system for synthetic persona generation, in accordance with an embodiment of the present application.

FIG. 2 presents a flowchart illustrating a process for generating a synthetic-population dataset that preserves statistical relationships among attribute data, in accordance with an embodiment of the present application.

FIG. 3A presents a flowchart illustrating a process for detecting dependencies among attributes and generating an influence data structure, in accordance with an embodiment of the present application.

FIG. 3B presents a diagram illustrating the visualization of attribute influence coefficients within the influence data structure, in accordance with an embodiment of the present application.

FIG. 4 presents a flowchart illustrating a process for generating a plurality of synthetic personas based on the influence data structure, in accordance with an embodiment of the present application.

FIG. 5 presents a block diagram illustrating a retrieval-augmented conversational system that generates analytical insights from synthetic personas, in accordance with an embodiment of the present application.

FIG. 6 presents a flowchart illustrating a process for analyzing dialog responses to identify correlations, trends, and behavioral patterns across synthetic personas, in accordance with an embodiment of the present application.

FIG. 7 illustrates an exemplary computer system that facilitates the synthetic persona generation and analysis processes, according to one embodiment of the instant application.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

Embodiments described herein solve the technical problem of generating accurate and comprehensive audience representations for market research by providing a synthetic-persona generation system that leverages the SynC (Synthetic Population via Gaussian Copula) methodology to learn complex attribute dependencies from a massive population dataset—representing over 32 million adults—and produces data-rich synthetic personas for a target population.

Existing persona-generation systems often rely on static demographic segmentation or generic large-language model (LLM) prompting. These approaches represent people as fixed templates or “hallucinated” entities rather than dynamic behavioral entities rooted in ground-truth data. While these systems may record traits associated with individuals, they frequently fail to reflect how those attributes are mathematically correlated (e.g., the non-linear relationship between income, location, and media consumption) or how they change with context. As a result, a legacy personas cannot accurately predict how one attribute influences another, limiting the ability to evaluate cause-and-effect relationships or simulate market responses at scale.

To address these issues, an enhanced persona management system, Smart Persona, is provided to construct synthetic personas that capture the statistical properties of real-world data while allowing controlled manipulation of attribute relationships. The system utilizes advanced artificial intelligence, specifically, Variational Autoencoder with Arbitrary Conditioning (VAEAC), to detect correlations, compute influence coefficients, and project individuals into a non-linear latent space. This architecture models how changes in one attribute affect others across more than 12,000 distinct data points per individual, including psychographics, transactional history, and media behaviors.

The resulting synthetic personas are generated by a Retrieval-Augmented Generation (RAG) engine that combines the generative capabilities of LLMs with the statistical rigor of our partner synthetic database. This architecture provides complete, data-rich audience representations that serve as the foundation for three primary analytical modules:
1. Interview: A qualitative engine where specific personas can be questioned directly, providing conversational insights rooted in their unique vector embeddings.
2. Scenario: A comparative analysis tool that tests hypotheses and marketing concepts across varied segments, utilizing HDBSCAN clustering to identify natural audience groupings.
3. Panel: A quantitative simulation engine capable of polling hundreds of synthetic respondents to generate statistical distributions, validated by Anchor Scores (groundedness) and Robustness Scores (consistency).

In response to market research inquiries, these synthetic personas provide answers that simulate actual human responses with a high level of confidence, reducing research latency from weeks to hours while providing scientifically validated outputs.

Scientific Methodology & Data Architecture: To address the limitations of “hallucinated” personas, the Smart Persona system employs a multi-stage pipeline that captures the statistical properties of real-world data while enabling controlled, counterfactual manipulation.

### 1. Synthetic Population Generation (SynC Methodology)

The foundation of the system is the SynC (Synthetic Population via Gaussian Copula) methodology. Rather than simple sampling, this approach ingests aggregated data (Census, Numeris, Vividata) and disaggregates it into individual profiles using a Gaussian Copula model. This allows the system to:
Model Dependencies: Capture complex non-linear dependencies between random variables (e.g., the correlation between income, location, and specific buying behaviors).
Perform Outlier Removal: Automatically detect and remove deviant samples that could skew microsimulation tasks.
Apply Marginal Adjustment: Ensure that when synthetic individuals are re-aggregated, they mathematically align with the original raw data sources.

Latent Space Modeling via VAEAC: To manage the high dimensionality of 12,000+attributes, the system utilizes Variational Autoencoder with Arbitrary Conditioning (VAEAC). Unlike linear dimensionality reduction (like PCA), the VAEAC projects synthetic personas into a non-linear latent space.

Function: This model estimates joint distributions of variables, allowing the system to generate stable vector embeddings for every individual.

Counterfactual Analysis: The VAEAC enables “what-if” scenarios (e.g., “How would this persona react if their age were lowered by 10 years but their income remained constant?”) by performing masked inference on specific attributes while maintaining statistical plausibility.

Dynamic Clustering (HDBSCAN): Instead of forcing personas into pre-defined categories using K-Means (which requires specifying k clusters a priori), the system employs HDBSCAN (Hierarchical Density-Based Spatial Clustering of Applications with Noise).
This algorithm identifies clusters of varying densities and shapes naturally occurring in the latent space, ensuring that segments are statistically robust rather than artificially imposed.
Fisher Scores are then calculated to interpret these clusters, ranking variables by their discriminating power to automatically label what makes a segment unique.

System Deliverables & Modules: The Smart Persona platform delivers concrete, actionable intelligence through three distinct interaction modules, accessible via UI, API, or Agentic Workflows.

### 1. The Interview Module (Qualitative)

Function: Facilitates direct, deep-dive conversations with specific synthetic personas powered by Gemini LLMs.
Technical Output: Full conversational transcripts where persona responses are grounded in their specific vector embeddings.
Deliverable: Qualitative insights regarding brand perception, barriers to purchase, and emotional drivers, with a target of reducing research cycles from weeks to under 48 hours.

### 2. The Scenario Module (Concept Testing)

Function: Tests hypotheses or marketing concepts (e.g., “Imposing a 4-day work week”) across varied persona samples.
Technical Output: A comparative analysis report highlighting differences in reception across segments (e.g., Gen Z vs. Rural Boomers) derived from the VAEAC latent space comparisons.

### 3. The Panel Module (Quantitative Simulation)

Function: Conducts large-scale quantitative surveys on hundreds of synthetic respondents.
Validation Metrics: To ensure data integrity, the system calculates and delivers two critical confidence scores with every dataset:
   Anchor Score (Groundedness): Uses a ROC AUC metric (target>0.8) to verify that the LLM's predictions are statistically explained by the persona's underlying attributes, not random hallucinations.
   Robustness Score (Consistency): Uses p-value statistics (Chi-square/Mann-Whitney U) to test if similar personas (neighbors in the latent space) yield consistent answers.

Technical Artifacts: The system generates and stores specific data artifacts in Google BigQuery for audit and re-use:
Personas Embeddings: Vector representations of individuals for proximity search.
Cluster Labels: Segment assignments derived from HDBSCAN.
Prediction Snapshots: Records of “what-if” inferences and their associated confidence intervals.

### Persona Management System

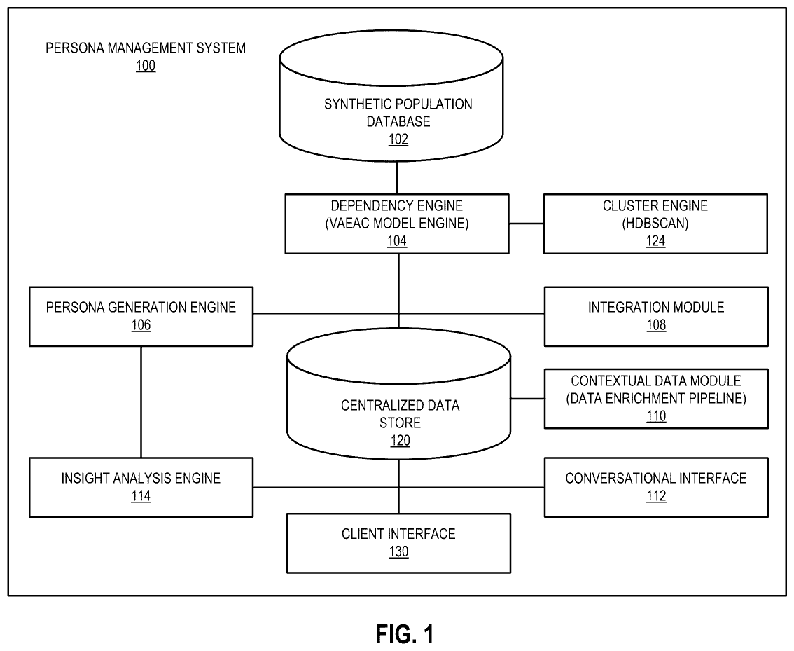

FIG. 1 presents a block diagram illustrating a system for synthetic persona generation, in accordance with an embodiment of the present application. In this example, persona management system 100 includes a synthetic population database 102, a dependency engine 104, a persona generation engine 106, an integration module 108, a contextual data module 110, a conversational interface 112, an insight analysis engine 114, a centralized data store 120, a cluster engine 124, and a client interface 130. These components are communicatively coupled through one or more internal data buses or network connections that facilitate bidirectional data flow and coordinated processing.

Synthetic population database 102 stores demographic, behavioral, and contextual attribute data obtained for one or more populations. The data stored in database 102 can include first-, second-, and third-party datasets, each contributing distinct categories of information to generate the attribute space used in persona generation. The first-and second-party datasets can be obtained from a client organization operating on a population of individuals. The client organization may collect this data through its own operations, such as purchase records, account registrations, loyalty-program interactions, or demographic surveys. Hence, the first-and second-party datasets can include demographic or transactional information about individuals in the population on which a client organization operates.

The third-party dataset can include behavioral records or survey responses obtained from another population of individuals. Such data may originate from research partners, affiliate entities, or internal studies that capture how individuals interact with services, products, or digital environments. These behavioral datasets provide system 100 with examples of how attributes co-vary in real-world contexts, forming the training basis for dependency detection.

System 100 can also obtain a contextual dataset, which can include market-level, environmental, or social-trend information obtained from external data providers, public databases, or syndicated data services. These sources can describe factors such as regional economic conditions, media consumption trends, or social-influence metrics that shape or contextualize behavior across populations. System 100 integrates these datasets into a unified dataset by aligning attributes, normalizing measurement scales, and resolving conflicts among overlapping fields. This integration ensures that attribute dependencies can be consistently analyzed across heterogeneous sources.

After these datasets are stored in synthetic population database 102, integration module 108 can unify these datasets by extracting relevant information from heterogeneous sources, normalizing schemas, aligning identifiers, and resolving inconsistencies. The unified dataset can then be stored in centralized data store 120, which can be a persistent data storage (e.g., a relational database). Centralized data store 120 can thus establish a normalized attribute space that can be queried for subsequent analysis.

Once the unified dataset is available, dependency engine 104 accesses the normalized attribute space to detect correlations and dependencies among variables originating from the combined datasets. Dependency engine 104 can determine correlation and influence coefficients that indicate how changes in one attribute may affect another. These dependency results are stored in centralized data store 120 and are continuously refined as new data are provided. Subsequently, cluster engine 124 performs clustering on the datasets using, for example, the HDBSCAN clustering algorithm. In one embodiment, dependency engine 104 can be a Variational Autoencoder with Arbitrary Conditioning (VAEAC) model engine. VAEAC is a neural probabilistic model based on variational autoencoder that can be conditioned on an arbitrary subset of observed features and then sample the remaining features. In addition, dependency analyzer 124 can be a cluster engine (for example, one that implements HDBSCAN, a clustering algorithm).

The dependency results are then utilized by persona generation engine 106 to generate synthetic personas that preserve the discovered inter-attribute relationships. Persona generation engine 106 performs probabilistic sampling, imputation, and constraint satisfaction based on the influence coefficients provided by dependency engine 104. Each generated persona represents an individual within the target population associated with the client organization, maintaining the statistical coherence of the population associated with the second-party dataset. The resulting persona records are stored in centralized data store 120 for contextual enrichment.

Following persona generation, contextual data module 110 associates each synthetic persona with external context obtained from real-time or periodic feeds. Such context may include market indicators, environmental variables, or policy updates that influence individual behavior. The contextual data are appended to the corresponding persona profiles in centralized data store 120, ensuring that future reasoning reflects the most current conditions surrounding the target population. These personas can then be used for analytical interaction to generate insight into the target population. In one embodiment, contextual data module 110 can be a data enrichment pipeline that implements AUTOENCODER, which is a type of neural network architecture designed to efficiently compress (encode) input data down to its essential features, and then to reconstruct (decode) the original input from this compressed representation.

When analytical interaction is requested, conversational interface 112 retrieves persona data and contextual information from centralized data store 120. Interface 112 can conduct retrieval-augmented reasoning, combining the stored persona attributes with documents or knowledge artifacts relevant to a given query. Interface 112 generates natural-language responses that represent persona-specific viewpoints, predicted decisions, or behavioral insights. The conversational results and supporting metadata are again stored in centralized data store 120 for interpretation. In some embodiments, conversational interface 112 operates as part of a retrieval-augmented generation (RAG)-based conversational system that integrates persona data, contextual information, and client knowledge sources to generate context-aware responses and analytical insights.

Insight-analysis engine 114 then processes the conversational outputs and related persona data to extract higher-order analytical patterns. The engine aggregates responses, detects recurring correlations and behavioral clusters, and generates structured outputs such as reports, dashboards, or decision recommendations. These insights are stored in centralized data store 120 and made available to authorized client systems for auditing and iterative refinement.

For example, client interface 130 can provide the operational control point for end users. Through this interface, users can configure data retrieval, monitor dependency metrics, initiate persona generation, initiate conversational analyses, and review analytical outcomes. Client interface 130 can communicate with other components of system 100 to manage workflow execution and display outputs. In combination, these interconnected components of system 100 form a processing pipeline that transforms heterogeneous input data into statistically coherent synthetic personas and actionable insights.

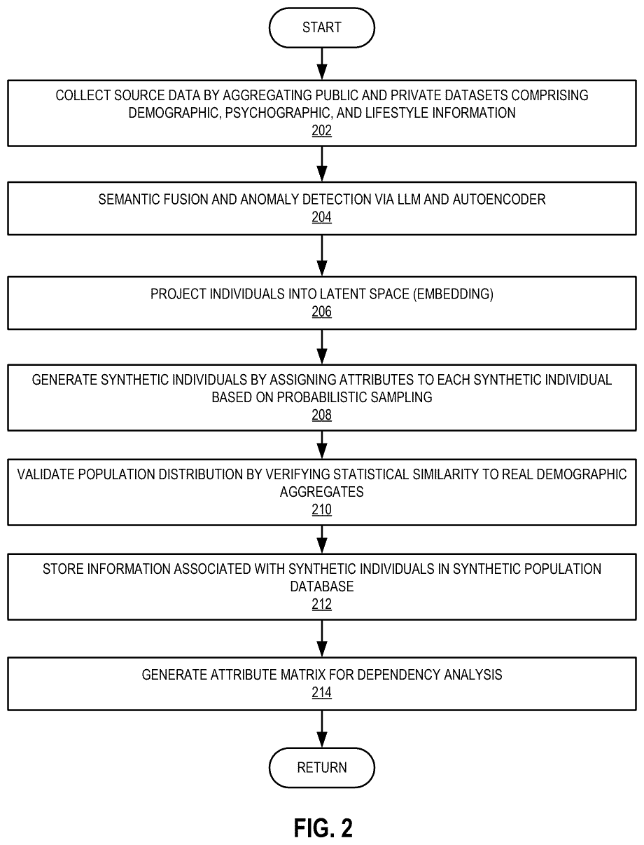

FIG. 2 presents a flowchart illustrating a process for generating a synthetic-population dataset that preserves statistical relationships among attribute data, in accordance with an embodiment of the present application. During operation, a persona management system collects source data by aggregating public and private datasets comprising demographic, psychographic, and lifestyle information (operation 202). These datasets may originate from first-, second-, and third-party sources and provide complementary perspectives on individual and household attributes. The aggregated data form the foundation for constructing a statistically representative synthetic population.

The system then performs semantic fusion and anomaly detection using a large-language model and an autoencoder (operation 204). Subsequently, in operation 206, the system can project individuals into a latent space (i.e., embedding the individuals). In the laten space, items (individuals) resembling each other are positioned closer to one another.

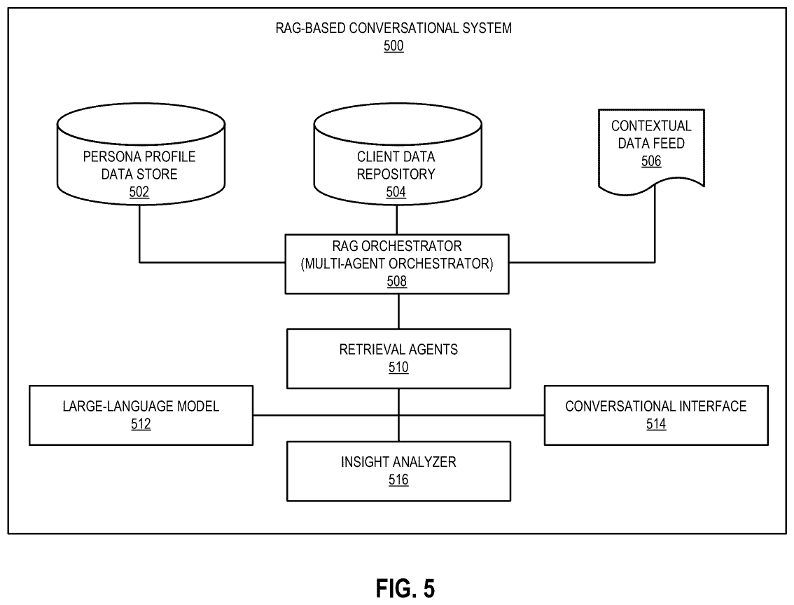

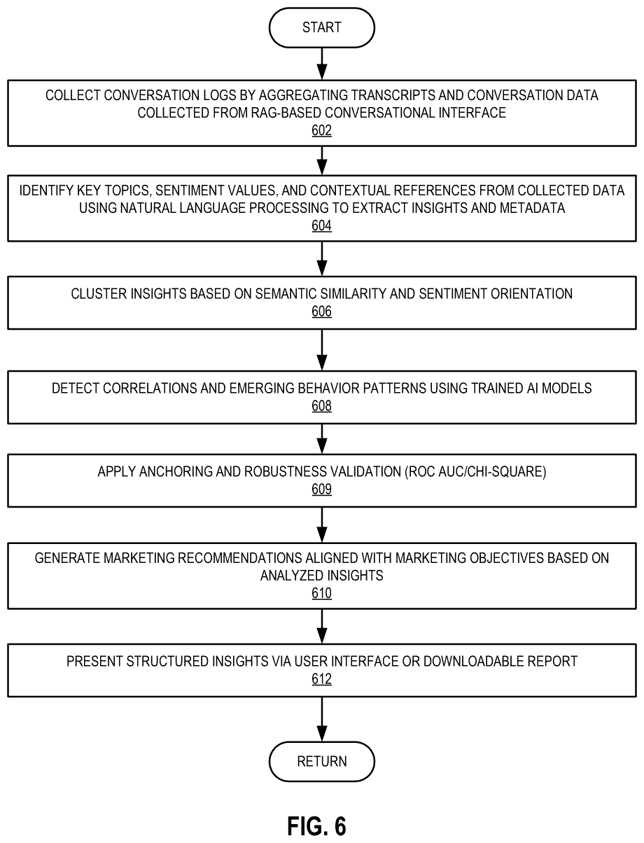

The system then generates synthetic individuals by assigning attributes to each synthetic individual based on probabilistic sampling (operation 208). To do so, the system can send the attributes of a respective synthetic individual to a generative AI engine, such as a large language model (LLM). In one embodiment, the system can generate a set of prompts based on the attributes for the LLM. In response, the LLM can create a unique persona specific to these attributes. The system can make these attributes persistent to each created unique persona by, for example, creating a separate LLM account associated with each persona, and sending the attribute-based prompts to the LLM under each account. As a result, each LLM account can then represent a specific synthetic persona. In further embodiments, the system can use retrieval-augmented generation (RAG) to store and retrieve each persona's unique set of attributes. More details on RAG-based persona storage and retrieval are described in conjunction with FIGS. 5 and 6 of this disclosure. The system can subsequently generate a synthetic dataset comprising a set of synthetic records, each representing a synthetic individual. Each synthetic record is generated based on the expected attribute distributions, thereby maintaining consistency with real-world population statistics. The system thus generates a simulated but data-consistent collection of individual-level records.

The system can validate population distribution by verifying statistical similarity to real demographic aggregates (operation 210). Validation compares aggregated measures from the synthetic dataset, such as age, income, and household composition, to those of the original data sources. Discrepancies are iteratively adjusted until the synthetic and observed distributions align within predefined tolerance thresholds. Once the validation is complete, the system stores information associated with synthetic individuals in a synthetic population database (operation 212). The database retains individual-level attributes, probability weights, and metadata that document the generation process.

Using these records as the input dataset, the system generates an attribute matrix for dependency analysis (operation 214). The matrix encodes all available attributes as structured variables suitable for correlation and influence-coefficient computation in later stages. This operation completes the formation of the synthetic-population dataset, which serves as the analytical foundation for the dependency and persona-creation processes.

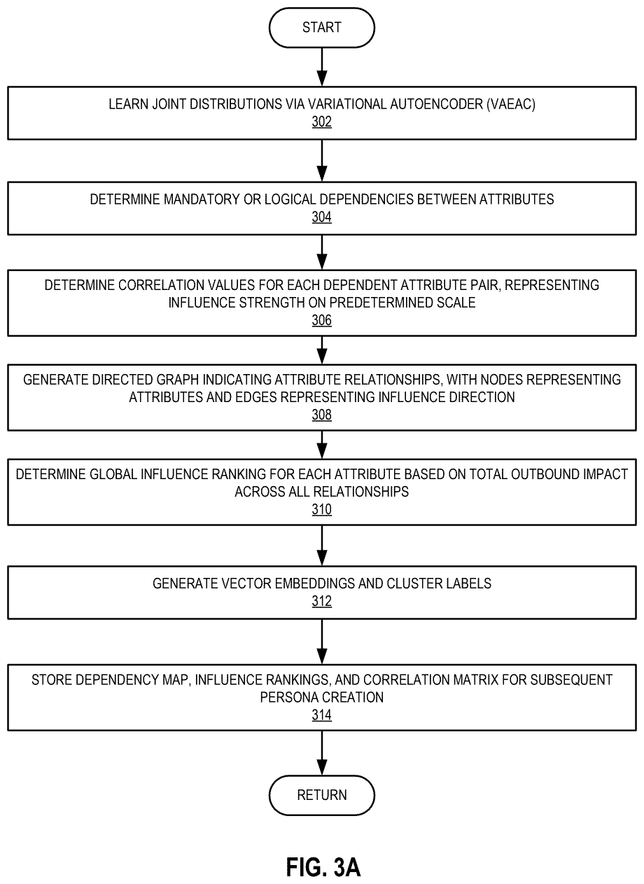

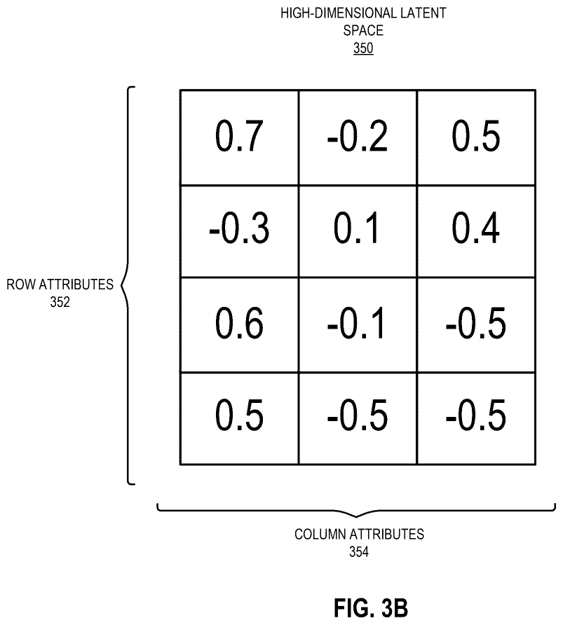

FIG. 3A presents a flowchart illustrating a process for detecting dependencies among attributes and generating an influence data structure, in accordance with an embodiment of the present application. During operation, a persona-management system learns joint distributions via a variational autoencoder (operation 302).

The system then determines mandatory or logical dependencies between attributes (operation 304). These dependencies represent fixed or rule-based relationships, such as categorical exclusivity or required co-occurrence between variables. For example, mandatory dependencies represent deterministic or rule-based relationships, such as hierarchical, categorical, or mutually exclusive attributes, which are to be preserved during persona generation. Recognizing mandatory dependencies ensures that subsequent sampling and analysis preserve logical consistency across attributes.

Subsequently, the system determines correlation values for each dependent attribute pair, representing the influence strength on a predetermined scale (operation 306). Each pairwise relationship can be quantified using correlation coefficients that reflect how strongly one attribute's variation is associated with another's. These values provide measurable indicators of interdependence within the dataset. The influence score may be expressed on a normalized scale from −1 to +1, where positive values indicate direct correlation, negative values indicate inverse correlation, and values near zero indicate weak or no influence. This scoring process can produce hundreds of millions of coefficients across the attribute space.

Based on the correlation values, the system generates a directed graph indicating attribute relationships, with nodes representing attributes and edges representing influence direction (operation 308). The graph encodes dependencies visually and computationally, showing how attributes influence one another. The directed edges define the flow of influence and enable subsequent identification of dominant variables within the network.

The system then determines global influence ranking for each attribute based on total outbound impact across all relationships (operation 310). The system aggregates outbound edge weights for every node to compute a global influence score, producing a ranked list of attributes ordered by their relative effect on others. Attributes with the highest outbound impact can become primary drivers for subsequent persona construction. These rankings also identify dominant behavioral or demographic factors that control the overall population dynamics. The results of this operation can be stored in a global ranking table, which lists each attribute in descending order of its total outbound influence computed across all relationships. The table serves as an index for identifying high-impact attributes that act as key drivers in the synthetic-population model.

Subsequently, the system creates generated vector embeddings and cluster labels (operation 312).

The generated influence matrix encodes all computed influence coefficients in a two-dimensional array, which can be referred to as a influence-matrix data structure. Here, rows represent source attributes and columns represent target attributes. Each matrix cell stores the numeric coefficient value between the corresponding attribute pair. The influence matrix supports sparse-matrix optimization for efficient access during persona sampling. The system then stores the dependency map, influence rankings, and correlation matrix for subsequent persona creation (operation 314). The stored values include the complete directed graph, global ranking tables, and the influence-matrix data structure. These outputs form the analytical basis for sequential probabilistic sampling and personality modeling.

FIG. 3B presents a diagram illustrating the visualization of attribute influence coefficients within the influence data structure, in accordance with an embodiment of the present application. In this example, high-dimensional latent space 350 visualizes relationships among attributes detected by the dependency-analysis process. Row attributes 352 are shown along the left axis, and column attributes 354 are shown across the bottom axis, forming a two-dimensional grid of coefficient values. Each cell represents an influence coefficient corresponding to a directional relationship between a respective pair of attributes. The coefficients may be calculated and normalized within a continuous numerical range that extends from negative to positive values, capturing both inverse and direct influences.

Optionally, an influence scale can be used to indicate the polarity and relative magnitude of these coefficients. The magnitude of influence may be displayed using color gradations, numerical ranges, or shading intensity proportional to the coefficient value. The distribution along the influence scale allows users or analytical modules to interpret how strongly and in what direction an attribute affects others within the modeled population.

Each row may thus represent an originating attribute (i), and each column may represent a receiving attribute (j), allowing a persona management system to retrieve directional influence values for computation and validation. High-dimensional latent space 350 can be implemented as a multidimensional numeric array that supports sparse-matrix optimization or weighted encoding to reduce computational overhead. During operation, the system references high-dimensional latent space 350 during sequential probabilistic sampling to preserve directional dependencies, as described in conjunction with FIG. 3A.

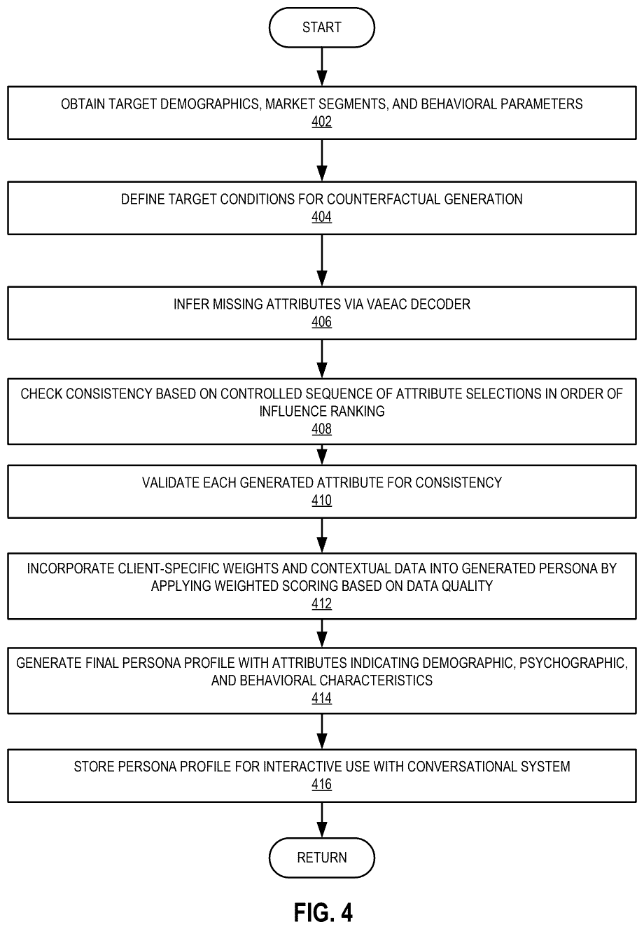

FIG. 4 presents a flowchart illustrating a process for generating a plurality of synthetic personas based on the influence data structure, in accordance with an embodiment of the present application. During operation, a persona management system obtains target demographics, market segments, and behavioral parameters (operation 402). These parameters represent the intended population scope, segmentation boundaries, and behavioral factors relevant to persona generation. The parameters may originate from client specifications, campaign objectives, or analytic models describing target audiences.

The system defines target conditions for counterfactual generation (operation 404). High influence attributes are identified from the global ranking table to serve as seeds for persona assembly, ensuring that key drivers anchor subsequent attribute selections and improve overall coherence. The system then infers missing attributes via a VAEAC decoder (operation 406). For each unassigned attribute, conditional probabilities are recalculated using coefficients from the influence matrix to preserve inter-attribute relationships.

Subsequently, the system checks consistency based on a controlled sequence of attribute selections in order of influence ranking (operation 408). Attributes are resolved according to their global influence scores, ensuring that dominant predictors are applied first. This ordering maintains logical consistency and prevents circular or contradictory assignments among correlated variables. The system then validates each generated attribute for consistency (operation 410). Validation includes verifying deterministic constraints, checking hierarchical relationships, and comparing sampled values against baseline statistical distributions derived from the synthetic population dataset. If inconsistencies are detected, the system resamples affected attributes or re-weights probabilities until alignment is achieved.

The system incorporates client-specific weights and contextual data into the generated persona by applying weighted scoring based on data quality (operation 412). Weighted scoring adjusts attribute importance and probability scaling to reflect client priorities or environmental context. The system then generates a final persona profile with attributes indicating demographic, psychographic, and behavioral characteristics (operation 414). The profile aggregates all validated attributes into a unified record representing an individual or segment archetype. In some embodiments, the system can further enrich each persona with Openness, Conscientiousness, Extraversion, Agreeableness, and Neuroticism (OCEAN) model personality vectors derived from correlations between observed behaviors and personality dimensions.

The system stores the persona profile for interactive use with the conversational system (operation 416). The completed persona records, together with their weighting metadata and validation results, are stored in the centralized data store and persona database. These stored personas serve as active entities for subsequent retrieval-augmented reasoning and analytical processing.

Retrieval-augmented generation (RAG) is a way to make an LLM answer using one's own documents or contextual data (which in this case is a unique persona's attributes) instead of only what the model has learned during training or conversation. The system first searches a knowledge store, which can be a vector database storing a persona's attributes and related contextual information, including past answers to questions. These retrieved data are then placed into the LLM's prompt as context, and the LLM produces an answer based on the provided prompt. This configuration provides individualized responses based on each unique persona, without needing to retrain the LLM whenever the data changes. In one embodiment, during indexing, every persona's attribute set is labeled with metadata like user_id, org_id, project, and access level, and the vector store or search layer uses those fields identifiers or filters, such that queries can be issued to each persona or a group of personas.

FIG. 5 presents a block diagram illustrating a retrieval-augmented conversational system that generates analytical insights from synthetic personas, in accordance with an embodiment of the present application. In this example, a RAG-based conversational system 500 operates as an analytic and interactive layer that interfaces with the generated personas generated by a persona management system. System 500 combines persona-specific data, contextual information, and client resources to generate responses and analytical insights.

System 500 includes a persona profile data store 502, a client data repository 504, a contextual data feed 506, a RAG orchestrator 508, one or more retrieval agents 510, a large-language model 512, a conversational interface 514, and an insight analyzer 516. These components are communicatively coupled to each other and share data flows coordinated by RAG orchestrator 508.

Here, persona profile data store 502 stores the synthetic persona records generated by a persona management system, such as system 100 of FIG. 1. The persona records can include demographic, psychographic, and behavioral attributes, as well as derived personality and contextual metadata. Data store 502 enables query-based retrieval of personas for simulated interactions, reasoning tasks, or behavioral analysis. Client data repository 504 stores organization-specific documents, communications, marketing materials, or transaction histories associated with the client entity deploying the system. These resources provide factual grounding and business context during response generation and insight analysis.

Contextual data feed 506 provides dynamic, time-sensitive data such as market indicators, environmental variables, or social trends. This feed ensures that the conversational system produces responses and analyses that reflect current external conditions or relevant events. RAG orchestrator 508 manages data flow and query execution across system 500. Upon receiving a query from a user via conversational interface 514, RAG orchestrator 508 coordinates retrieval requests, merges results from persona profile data store 502, client data repository 504, and contextual data feed 506, and passes the aggregated context to large-language model 512. Note that, in one embodiment, RAG orchestrator 508 can be a multi-agent orchestrator, such as LangGraph.

Retrieval agents 510 perform specialized search and filtering tasks across internal and external data repositories. Each retrieval agent can target a specific domain—such as persona attributes, client data, or contextual intelligence—and return ranked content to the orchestrator. This modular retrieval framework supports multi-source reasoning and adaptive document selection. In one embodiment, retrieval agents 510 can be specialized agents (specific to topics such as brand, finance, or research).

Large-language model 512 serves as the generative reasoning engine of the system. It receives the merged context from RAG orchestrator 508, conditions it on persona attributes, and generates responses that reflect the persona's behavioral and linguistic tendencies. The large-language model may further apply retrieval-augmented reasoning to synthesize new insights or recommendations based on the assembled context.

Conversational interface 514 provides a user-facing communication layer for receiving queries and delivering responses. Interface 514 supports both text-based and multimodal interactions, allowing clients or analysts to converse with synthetic personas, explore scenario outcomes, or request analytical interpretations. Interface 514 also logs interactions for downstream trend and sentiment analysis. Insight analyzer 516 processes conversation logs, persona responses, and retrieved content to identify recurring patterns, behavioral trends, or emerging topics of interest. Analytical outputs can include correlation reports, summary dashboards, or actionable recommendations. Insight analyzer 516 thus transforms persona-based interactions into measurable intelligence that informs marketing, communication, or strategic decision-making processes. In this way, system 500 integrates the synthetic persona profiles with real-world and contextual data sources to produce dynamic, insight-driven interactions.

FIG. 6 presents a flowchart illustrating a process for analyzing dialog responses to identify correlations, trends, and behavioral patterns across synthetic personas, in accordance with an embodiment of the present application. During operation, a RAG-based conversational system collects conversation logs by aggregating transcripts and conversation data collected from the RAG-based conversational interface (operation 602). The aggregated dataset includes persona responses, user prompts, contextual references, and metadata such as timestamps or conversation length. This operation ensures that all conversational interactions are stored in a normalized format suitable for linguistic and behavioral analysis.

The system then identifies key topics, sentiment values, and contextual references from collected data using natural language processing to extract insights and metadata (operation 604). In some embodiments, topic modeling and sentiment-analysis algorithms detect the dominant themes and emotional tone within persona dialogues. Extracted metadata may also capture co-occurrence patterns and contextual relationships that provide interpretive depth for subsequent clustering.

Subsequently, the system clusters insights based on semantic similarity and sentiment orientation (operation 606). This clustering process organizes similar ideas, reactions, or conversational outcomes into clusters that represent distinct behavioral or attitudinal categories. The clustering output forms the basis for detecting higher-level correlations and emerging patterns. The system then detects correlations and emerging behavior patterns using trained AI models (operation 608). These models analyze cross-cluster relationships to determine dependencies between sentiments, topics, and persona attributes. The detected patterns can indicate shifts in public perception, latent needs, or recurring behavioral tendencies across personas or demographic groups. Subsequently, the system can apply anchoring and robustness validation (operation 609)

The system then generates marketing recommendations aligned with marketing objectives based on analyzed insights (operation 610). Recommendations may include strategy refinements, message adaptations, or persona segmentation adjustments to improve campaign effectiveness. The output is designed to be interpretable by decision-support tools or marketing automation platforms. Upon generating the marketing recommendations, the system presents structured insights via user interface or downloadable report (operation 612). These structured outputs may take the form of dashboards, comparative charts, or textual summaries that synthesize analytic findings into actionable intelligence.

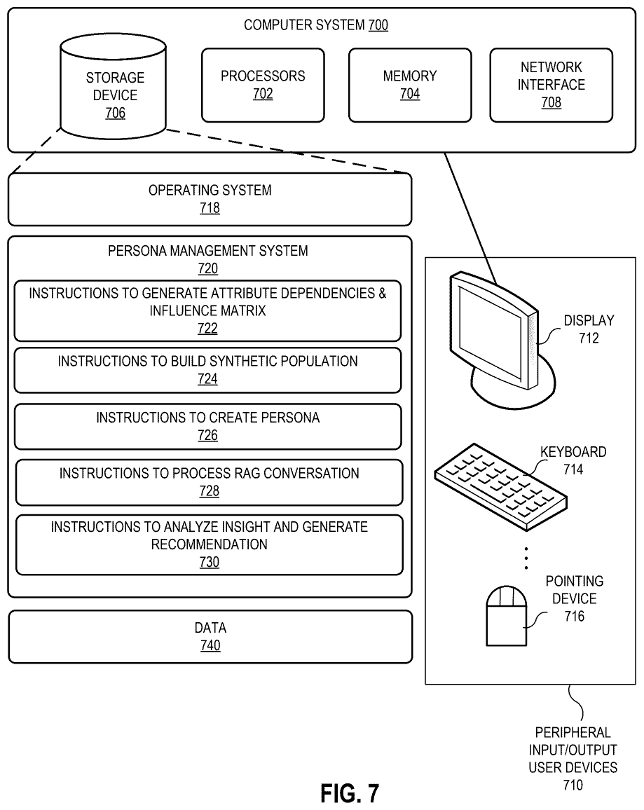

FIG. 7 illustrates an exemplary computer system that facilitates the synthetic persona generation and analysis processes, according to one embodiment of the instant application. A computer system 700 includes a processor 702, a memory 704, and a storage device 706. Furthermore, computer system 700 can be coupled to peripheral input/output (I/O) user devices 710, e.g., a display device 712, a keyboard 714, and a pointing device 716. Storage device 706 can store an operating system 718, a persona management system 720, and data 740. Computer system 700 can be implemented as a standalone computer, a distributed computing cluster, or a cloud-based computing environment.

Persona management system 720 can include instructions, which, when executed by computer system 700, can cause processor 702 to perform methods and/or processes described in this disclosure. In some embodiments, persona management system 720 can form part of a persona management system, similar to system 100 shown in FIG. 1.

Persona management system 720 can include instructions 722 to generate attribute dependencies and an influence matrix, which may be similar to the processes described above in relation to FIGS. 3A and 3B; instructions 724 to build a synthetic population, as described above in relation to operation 214 of FIG. 2; instructions 726 to create a synthetic persona, as described above in relation to FIG. 4; instructions 728 to process RAG conversations, as described above in relation to FIG. 5; and instructions 730 to analyze insights and generate recommendations, as described above in relation to FIG. 6. Data 740 can include population data, persona profiles, influence matrices, conversation transcripts, and generated insight records.

In general, embodiments of the instant application provide a persona management system that can receive, from a plurality of data sources, attribute data representing demographic, behavioral, and contextual variables for a first population of individuals. The system can then generate a synthetic-population dataset that preserves statistical relationships among the attribute data. Subsequently, the system can detect dependencies among the attributes based on correlation and influence coefficients and generate an influence data structure representing the strength and direction of attribute relationships. The system can then sample attributes from the synthetic-population dataset using the influence data structure to generate a plurality of synthetic personas representing a second population of individuals. The system can store the plurality of synthetic personas in a persona database. The system can then generate a response indicating analytical insights from the synthetic personas using retrieval-augmented reasoning.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

In the examples described herein, the processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, FPGAs, dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer executed method for synthetic persona generation, the method comprising:
receiving, from a plurality of data sources, attribute data representing demographic, behavioral, and contextual variables for a first population of individuals;
generating a synthetic-population dataset that preserves statistical relationships among the attribute data;
detecting dependencies among the attributes based on correlation and influence coefficients;
generating an influence data structure representing strength and direction of attribute relationships;
sampling attributes from the synthetic-population dataset using the influence data structure to generate a plurality of synthetic personas representing a second population of individuals;
storing the plurality of synthetic personas in a persona database; and
generating a response report indicating analytical insights from the synthetic personas by aggregating persona-specific dialog responses using retrieval-augmented reasoning in conjunction with a large-language model; and
displaying the response report on a client interface.

2. The method of claim 1, wherein detecting the dependencies comprises applying a machine-learning model to determine how a change in one attribute affects at least one other attribute within the synthetic-population dataset.

3. The method of claim 1, wherein generating the synthetic-population dataset comprises merging a first dataset comprising demographic or transactional information of the second population, a second dataset comprising behavioral records or survey responses of the first population, and a third dataset comprising market, environmental, or social-trend information obtained from external data providers.

4. The method of claim 1, wherein generating the plurality of synthetic personas comprises performing sequential probabilistic sampling that preserves conditional probabilities derived from the influence data structure.

5. The method of claim 1, wherein generating the response report comprises:
retrieving persona-specific information from the persona database; and
generating a response by feeding a prompt constructed based on the retrieved persona-specific information to the large-language model.

6. The method of claim 5, further comprising analyzing dialog transcripts for dialog with the large-language model to identify emergent behavioral patterns across personas.

7. The method of claim 5, wherein generating the response further comprises:
identifying correlations, trends, or emerging patterns across a plurality of persona interactions; and
generating the response representing an insight or recommendation based on the identified patterns.

8. The method of claim 1, further comprising applying a neural-network model to rank attributes by correlation strength and direction.

9. A non-transitory computer-readable storage medium storing instructions that, when executed by a computer, cause the computer to perform a method for synthetic persona generation, the method comprising:
receiving, from a plurality of data sources, attribute data representing demographic, behavioral, and contextual variables for a first population of individuals;
generating a synthetic-population dataset that preserves statistical relationships among the attribute data;
detecting dependencies among the attributes based on correlation and influence coefficients;
generating an influence data structure representing strength and direction of attribute relationships;
sampling attributes from the synthetic-population dataset using the influence data structure to generate a plurality of synthetic personas representing a second population of individuals;
storing the plurality of synthetic personas in a persona database;
generating a response report indicating analytical insights from the synthetic personas by aggregating persona-specific dialog responses using retrieval-augmented reasoning in conjunction with a large-language model; and
displaying the response report on a client interface.

10. The non-transitory computer-readable storage medium of claim 9, wherein detecting the dependencies comprises applying a machine-learning model to determine how a change in one attribute affects at least one other attribute within the synthetic-population dataset.

11. The non-transitory computer-readable storage medium of claim 9, wherein generating the synthetic-population dataset comprises merging a first dataset comprising demographic or transactional information of the second population, a second dataset comprising behavioral records or survey responses of the first population, and a third dataset comprising market, environmental, or social-trend information obtained from external data providers.

12. The non-transitory computer-readable storage medium of claim 9, wherein generating the plurality of synthetic personas comprises performing sequential probabilistic sampling that preserves conditional probabilities derived from the influence data structure.

13. The non-transitory computer-readable storage medium of claim 9, wherein generating the response report comprises:
retrieving persona-specific information from the persona database; and
generating a response by feeding a prompt constructed based on the retrieved persona-specific information to the large-language model.

14. The non-transitory computer-readable storage medium of claim 13, wherein the method further comprises analyzing dialog transcripts for dialog with the large-language model to identify emergent behavioral patterns across personas.

15. The non-transitory computer-readable storage medium of claim 13, wherein generating the response further comprises:
identifying correlations, trends, or emerging patterns across a plurality of persona interactions; and
generating the response representing an insight or recommendation based on the identified patterns.

16. The non-transitory computer-readable storage medium of claim 9, wherein the method further comprises applying a neural-network model to rank attributes by correlation strength and direction.

17. A computer system, comprising:
a storage device;
a processor;
a non-transitory computer-readable storage medium storing instructions, which when executed by the processor causes the processor to perform a method for synthetic persona generation, the method comprising:
receiving, from a plurality of data sources, attribute data representing demographic, behavioral, and contextual variables for a first population of individuals;
generating a synthetic-population dataset that preserves statistical relationships among the attribute data;
detecting dependencies among the attributes using a dependency engine that determines correlation and influence coefficients;
generating an influence data structure representing strength and direction of attribute relationships;
sampling attributes from the synthetic-population dataset using the influence data structure to generate a plurality of synthetic personas representing a second population of individuals;
storing the plurality of synthetic personas in a persona database;
generating a response report indicating analytical insights from the synthetic personas by aggregating persona-specific dialog responses using retrieval-augmented reasoning in conjunction with a large-language model; and
displaying the response report on a client interface.

18. The computer system of claim 17, wherein detecting the dependencies comprises applying a machine-learning model to determine how a change in one attribute affects at least one other attribute within the synthetic-population dataset.

19. The computer system of claim 17, wherein generating the response report comprises:
retrieving persona-specific information from the persona database; and
generating a response by feeding a prompt constructed based on the retrieved persona-specific information to the large-language model.

20. The computer system of claim 19, wherein the method further comprises analyzing dialog transcripts for dialog with the large-language model to identify emergent behavioral patterns across personas.
